(19) United States
(12) Patent Application Publication
(10) Pub. No.: US 2015/0189191 A1
(43) Pub. Date: Jul. 2, 2015

(54) PROCESS AND SYSTEM FOR VIDEO PRODUCTION AND TRACKING OF OBJECTS

(71) Applicant: Telemetrio LLC, Lathrup Village, MI (US)

(72) Inventor: Marco Cucco, Lathrup Village, MI (US)

(73) Assignee: Telemetrio LLC, Lathrup Village, MI (US)

(21) Appl. No.: 14/524,342

(22) Filed: Oct. 27, 2014

Related U.S. Application Data
(60) Provisional application No. 61/921,378, filed on Dec. 27, 2013.

(51) Int. Cl. H04N 5/265; H04N 5/272

(52) U.S. Cl. CPC H04N 5/265; H04N 5/272

(57) ABSTRACT

A process for producing a video output of an event at a venue using a plurality of video imaging devices capturing images of the event from different perspectives of the venue includes steps of generating background images for each feed, subtracting the background image from each feed to generate an extracted foreground image for each feed, binarizing the extracted images for each feed to generate a collection of blobs, calculating centroid coordinates and circumscribing polygon vertices coordinates for each image, storing the coordinates, repeating the above steps at regular time increments, and selecting a feed for output based on the stored coordinates.

### CROSS-REFERENCE TO RELATED APPLICATIONS

This application claims the benefit of U.S. Provisional Application No. 61/921,378, filed Dec. 27, 2013, which is incorporated herein by reference.

### STATEMENT REGARDING FEDERALLY FUNDED RESEARCH

This invention was not made under contract with an agency of the U.S. Government, nor by any agency of the U.S. Government.

### FIELD OF THE DISCLOSURE

This disclosure relates to the production of a video composition from a plurality of video feeds and to tracking of objects within the feeds, and more particularly to processes and systems for automatically generating a video production in real time or for later viewing that displays images from an event at a venue, and displays statistical information pertaining to the motions of objects in the video feeds.

### BACKGROUND OF THE DISCLOSURE

Systems and methods for automated multiple camera systems which can provide nearly continuous display of a figure moving through different fields of view associated with different video cameras are known (e.g., U.S. Pat. No. 6,359,647). Systems for simultaneously tracking multiple bodies in a closed structured environment are also known (e.g., U.S. Publication No. 2003/0179294 A1).

There remains a need for improved automated video tracking and production systems and methods that facilitate the automatic production of a high quality video composition from a plurality of video imaging devices that together are arranged to capture all actions within the boundaries of a venue in which an event involving movement of multiple objects is taking place.

### SUMMARY OF THE DISCLOSURE

In accordance with certain aspects of this disclosure, a process for producing a video output from a plurality of video feeds generated by a corresponding plurality of video imaging devices is provided. The process may include steps of generating a background image for each video feed, subtracting the background image from each video feed to generate an extracted foreground image of objects within the venue, and binarizing the extracted foreground image for each feed to generate a collection of blobs that correspond with the objects in the foreground image for each feed. The coordinates of the centroid of the collection of blobs for each video feed are calculated, and coordinates for vertices of a polygon circumscribing the collection of blobs in each binarized extracted image for each video feed are calculated. The calculated centroid and vertices coordinates are stored. The steps associated with obtaining a binarized extracted image for each video feed, calculating the centroid coordinates and vertices coordinates is repeated at regular time increments. The stored coordinates are then used for selecting a particular feed for the output video. These steps are repeated to produce a video composition that may be viewed in real time during the event or after the event.

The video imaging devices used in certain aspects of this disclosure can have a pan function that allows the video imaging device to be rotated around a vertical axis or translated along a horizontal path, and the pan function can be controlled in response to changes in the centroid or polygon vertices coordinates.

The video imaging devices used in certain aspects of this disclosure can have a tilt function that allows rotation around a horizontal axis or translation along a vertical path, and the tilt function can be controlled in response to changes in the centroid or polygon vertices coordinates.

In certain aspects of this disclosure, the pan function, the tilt function, or both the pan function and the tilt function can be controlled to compensate for displacement of the centroid away from a center point of the feed image. In certain aspects of this disclosure, the tilt or pan can be prevented from occurring unless a predetermined threshold displacement has been exceeded. In certain other aspects of this disclosure, the tilt or pan can be adjusted at a rate proportional to the rate of displacement of the centroid from the center point of the feed image, or the rate of displacement of an edge of the circumscribing polygon.

In certain aspects of this disclosure, at least one of the video imaging devices can have a zoom function that is adjusted in response to at least one of expansion of the polygon circumscribing the collection of blobs, contraction of the polygon circumscribing the collection of blobs, and movement of the centroid at a rate exceeding a predetermined value. In certain aspects of this disclosure, the zoom function can be adjusted at a rate proportional to a rate at which the polygon expands or contracts. In certain aspects of this disclosure, the zoom function is not adjusted unless a predetermined threshold expansion or contraction has occurred.

In certain aspects of this disclosure, venue coordinates are calculated for a centroid associated with the image coordinates of the centroid of at least one of the video feeds, and the video feed having an associated video imaging device closest to the venue coordinates of the centroid is selected for output. In certain aspects of this disclosure, the output is not switched to another feed unless a different video imaging device remains nearest the venue coordinates of the centroid for a predetermined time period.

In certain aspects of the disclosure, a track record is maintained for each blob, each track record includes at least an identifier for each object associated with the blobs in the feed images, venue coordinates of each blob at each time increment, and at least one identifying characteristic. Blobs at each time increment are associated with a track record based on comparisons of at least one of image coordinates, venue coordinates, and an identifying characteristic.

In certain aspects of this disclosure, a new track record is established for any blobs that cannot be matched to an existing track record.

In certain aspects of this disclosure, the track record of any single blob that separates into at least two different blobs that can be associated with an existing track record is appended to that existing track record.

In certain aspects of this disclosure, identifiers are manually entered or changed before, during or after the event.

In certain aspects of this disclosure, the selection of a feed based on centroid and/or vertices coordinates is suspended upon detection of cues indicative of special circumstances.

In accordance with other aspects of this disclosure, a system for generating a video output from a plurality of video feeds includes a plurality of video imaging devices that are capable of generating a video image of at least a portion of a venue, the plurality of video imaging devices together being able to display substantially the entire venue, a background generator for developing a background image for each video feed, a foreground extraction module for subtracting the background image for each video feed to develop an extracted foreground image for each video feed, and a binarizing module for generating a collection of blobs corresponding with objects in the extracted foreground image for each feed. A processor is used for calculating image coordinates for a centroid of the collection of blobs in the binarized extracted image for each video feed, and for calculating image coordinates for vertices of a polygon circumscribing the collection of blobs in each binarized extracted image for each video feed. A memory module is provided for storing the centroid and vertices image coordinates for each video feed. A controller instructs the various modules to repeat their respective functions at regular time increments. A selection module chooses a particular video feed for output based on at least one of the centroid coordinates and the vertices coordinates.

A panning mechanism can be provided on at least one of the video imaging devices to facilitate rotation of the video imaging device around a vertical axis or translation along a horizontal path. The panning mechanism can be operated in response to changes in the image coordinates of the centroid or of the vertices coordinates.

A tilting mechanism can be provided on at least one of the video imaging devices to facilitate rotation of the video imaging device around a horizontal axis or translation along a vertical path in response to changes to the centroid coordinates or of the vertices coordinates.

A zooming mechanism can be provided on at least one of the video imaging devices to expand or contract the field of view of a video image generated by the video imaging device to facilitate adjustments responsive to expansion or contraction of the polygon circumscribing the collection of blobs or movement of the centroid.

### BRIEF DESCRIPTION OF THE DRAWINGS

FIG. 1 is a diagram illustrating how objects in a video image are assigned or associated with a track record that at minimum maintains information pertaining to position of the object as a function of time.

FIG. 2 shows how objects in a current frame are evaluated for assignment to a track record.

FIG. 3 shows how objects are tracked over time.

FIG. 4 shows how two players in a frame merge to form a single blob in a binarized extracted foreground image.

FIG. 5 illustrates how the merger shown in FIG. 4 results in a single track record.

FIG. 6 shows how merged or occluded blobs can split, resulting in separation of a composite track record into two independent track records.

FIG. 7 shows a venue and a plurality of video imaging devices positioned around the venue to capture action (movement) within the venue.

FIG. 8 is a schematic illustration of a system for generating a video output from a plurality of video feeds.

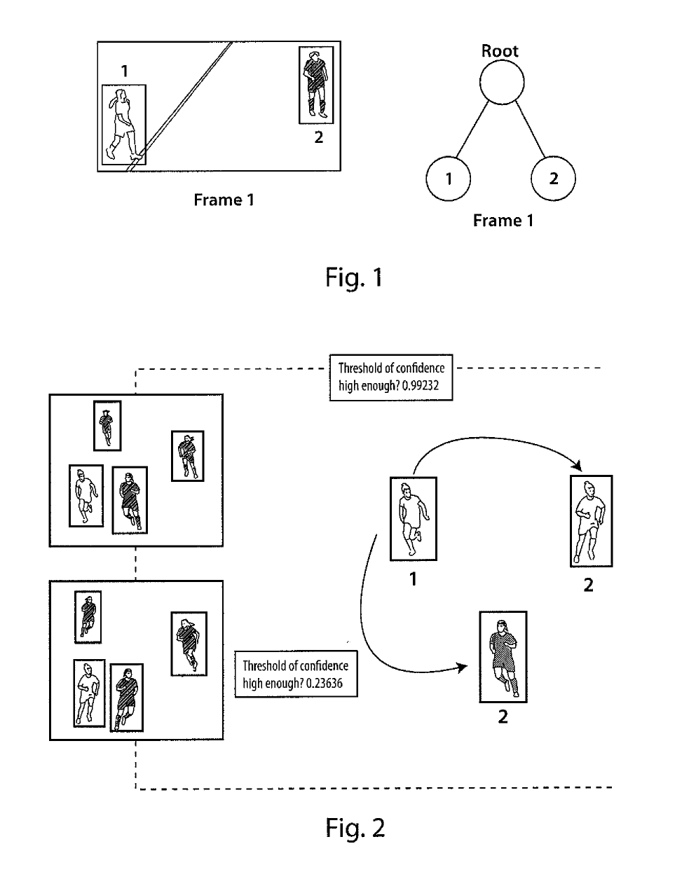

### DETAILED DESCRIPTION OF THE DISCLOSURE

The disclosed process of generating a video output from a plurality of video feeds involves first obtaining extracted foreground images from each feed in the form of binarized blobs representative of moving objects within a venue during an event. Next, centroid coordinates for the blobs in each feed and vertices of a polygon circumscribing the blobs in each feed are determined and recorded. These steps are repeated at regular time increments (typically at a rate of several times per second for sporting events), and a feed is selected for output based on a combination of the recorded data. For example, the centroid image coordinates for a particular feed that is believed to be representative of the action can be converted or translated into venue coordinates, and the video imaging device closest to the venue coordinates of that centroid can be selected for output.

An event can be any activity of interest having a duration that can be predefined with a starting time and an ending time. Alternatively, the starting time and/or the ending time can be adjusted manually or can be based on visual or audio cues indicative of the starting and/or ending time of an event.

The venue can be generally any type of facility in which an event can take place, such as an athletic field, a sports complex, a theatre, a church, etc. The event can, for example, be a sports event, such as a soccer, basketball, baseball, football or other ball game, a theatrical event, such as a play or concert, or a social or religious event, such as a wedding. The systems and method may also have application in surveillance and crime prevention.

The video imaging devices may be any type of image sensor that converts an optical image into an electronic signal. Examples include semiconductor charge-coupled devices (CCD) and active pixel sensors in complementary metal-oxide-semiconductor (CMOS) or N-type metal-oxide-semiconductor (NMOS, live MOS) technologies. Analog video cameras may also be used, in which case, the analog signal from the camera may be converted into a digital signal for subsequent processing (e.g., to extract the foreground and binarize the extracted foreground).

A background image for each video feed is generated. This can be done prior to an event when there are no moving objects in the venue. However, this can also be done substantially continuously or at regular intervals by developing a background from recent video frames by subtracting moving objects characterized by a substantial difference in color or light intensity (a difference that exceeds a threshold value). By updating the background on a regular basis, it is possible to account for changes in the background associated with changes in lighting conditions, movement of inanimate objects, etc.

Subtraction of the background (non-moving or very slow moving objects) from the current video image for each video imaging device generates foreground images of moving objects (e.g., players, referees, and the ball in various ball games played on a field or court).

Binarization is a process in which each pixel of the video image produced after subtraction of the background image from the current video image for each video imaging device is assigned either black or white, such that the resulting binarized extracted foreground image shows all rapidly moving objects as black blobs and all stationary or very slowly moving objects as a white background. Generally, pixels from the pre-binarized, extracted image are assigned black if they are darker than a threshold value and otherwise assigned white.

The centroid coordinates for each video frame of each video imaging device can be calculated by deter mining the pixel count or total area of the blobs representing a moving object, determining the moments, and dividing the moments by the area. A weighted centroid can be used to more accurately determine the position coordinates of the centroid to account for the fact that objects closer to the video imaging device appear to be larger than those further away.

The polygon circumscribing the collection of blobs in each of the binarized extracted images for each video feed can be a polygon of a predetermined shape, such as a square, rectangle, triangle, etc., that just barely includes all of the blobs in the image, or it can be an irregularly shaped polygon defined by the outermost blobs that can be connected to define a shape that encompasses all of the blobs in the image.

The coordinates determined for the centroids and vertices are stored on a memory device such as a random access memory (RAM) for subsequent use.

The steps of obtaining a binarized extracted foreground image, generating centroid coordinates and vertices coordinates of a circumscribing polygon, and storing the coordinates is repeated. For security or surveillance monitoring, the frequency at which these computations are performed can be relatively low (e.g., 1-3 times per second), while for sports events the frequency should be relatively high (e.g., at least 5 to 10 times per second).

Selection of a particular feed for output can be based on criteria dependent on at least one of the recently determined centroid coordinates or the recently determined vertices coordinates. For example, the selection can be based on the feed corresponding to the video imaging device that is nearest the venue coordinates corresponding to the centroid coordinates of a particular feed. Alternatively, as another example, the selection can be based on the feed corresponding to the video imaging device that is nearest the venue coordinates corresponding to the fastest moving edge of the circumscribing polygon of a particular feed.

In those embodiments, employing video imaging devices having a pan function (the ability to direct the imaging device to the left or right), the recent coordinates can be used for controlling the panning, such as to keep the centroid at the center of the feed image. Similarly, in those embodiments employing video imaging devices having a tilt function (the ability to direct the imaging device upwardly or downwardly), the recent coordinates can be used for controlling the tilting, such as to keep the centroid at the center of the feed.

In order to provide smooth movement of the video imaging devices during panning, tilting or both panning and tilting, the controlling processor can be configured to delay such functions until a predetermined threshold displacement of the centroid from the center of the feed image is exceeded. Also, the rate at which panning, tilting or both panning and tilting is done can be controlled so that the movements of the video imaging devices are proportional to the displacement, the rate of displacement, or a combination of displacement and rate of displacement.

Although the tilt and pan functions have been described in terms of rotations or translations that physically move the video imaging devices, it is possible to achieve a tilt or pan function, or both a tilt and pan function electronically, such as by cropping an image having a large field of view. Such electronic panning and tilting functions may be used in the disclosed processes and systems.

At least one of the video imaging devices can be provided with a zoom function, which can be an optical zoom function or an electronic zoom function, that is adjusted in response to recently accumulated coordinate data (e.g., data acquired over the most recent few seconds). For example, the zoom function can respond to changes in the shape or size of the polygon circumscribing the collection of blobs. The video image can zoom out if the polygon is expanding, or zoom in if it is contracting. Alternatively, the video image can zoom out if the centroid is moving at a rate beyond a threshold value. This can be done in conjunction with panning or tilting. The rate of zoom can be proportional to polygon expansion or contraction, or proportional to the rate (velocity) at which the centroid is moving. As with the tilt and pan functions, the zoom function can be delayed until a threshold expansion, contraction or centroid displacement is exceeded.

In order to smooth transitioning from one video imaging device to another, especially when smaller displacements in opposite directions are occurring rapidly, transitions can be delayed until a threshold value associated with a transitioning criteria is exceeded. For example, if the video imaging device selection criteria is based on proximity of the centroid venue coordinates with the video imaging devices, switching from a currently outputted feed from a first video imaging device to a different feed associated with a second video imaging device that is closer to the action can be delayed until the second video imaging device is nearest the action for a predetermined time period.

In order to keep track of players or other objects in the field or venue, the system uses a data structure to hold information frame-to-frame about all moving objects inside the venue. The tracked blobs represent a self contained movable object that possesses intrinsic properties not shared with any other object, the sequence of tracked blobs in the image represent the track records. The tree structure used contains nodes as middle and end points. Each node in this structure will contain:

Coordinates of the blob in the image

Features of the tracked blob

Number of frames being processed

Sons of the node

For an initial state of the tree the tracking is done by inserting all blobs inside the data structure as branches.

For all future states of the tree, the immediate next frame of the video is analyzed in order to determine the next state of each of the leaf nodes in the tree. A surrounding area is analyzed based on the previous frame coordinates of the blob to determine a human movable distance, any blob found in this area is then compared to the previous and their histogram properties measured in order to determine a direct link between the two images.

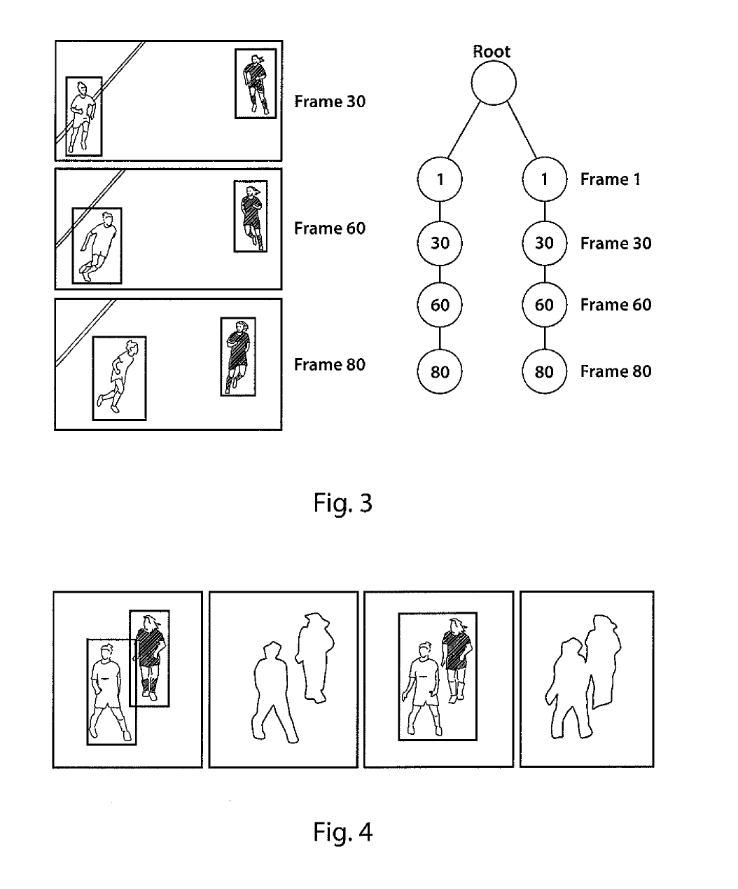

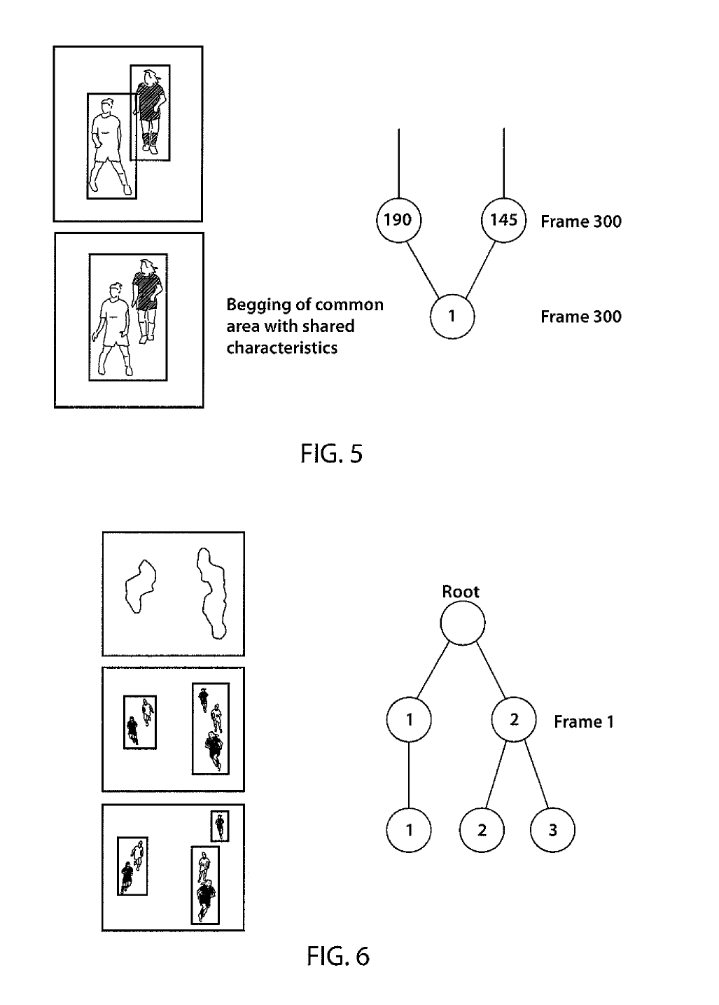

This process represents the “linkage” between blobs of different frames into one sequence of tracked blobs generating a track record for a player. The sequence can hold N number of blobs tracked per player across the game (if no occlusion occurs the tree would grow as FIG. 3 shows).

This represents the simplest case of tracking continuous blobs in the frame with no overlapping or entanglement between them. However, football (soccer) is a contact sport and this means that players will merge into a unique position or close positions where the system cannot identify and differentiate one from the other. For this case we use a split-merge logic in order to keep a clean and consistent track of the blobs.

Merging of two blobs means the fusion of their binarized areas into one connected area in the binary image. This area contains the merged players and while the players remain as merged blobs they share characteristics and properties since they become a unique node in the tree. FIG. 6 represents the tree state of two nodes merging.

Merging of two blobs into one area represents a problem since they need to be reconciliated right after the split and there is not always information available to perform reconciliation of blobs with high confidence, because of the way blobs are merged and split in the system, some high level assumptions can be used.

It may not be feasible to determine when a blob contains only one player. All blobs at all times contain one player and multiple players at the same time (superposition of states). Therefore all nodes in the tree belong to one player and to multiple players at the same time (common and single area), this implies that all nodes are shared and unique at the same time until two players leave a common area.

Spatial information cannot be used to untangle merged blobs as players can enter and leave the merge area in any position and there is no safe assumption when they might leave in a specific place (as to aid the blob reconciliation method).

Merged blobs will always share their characteristics such as touches, displacement, etc. Even if this makes statistics inaccurate as there is no other way to keep this information beside the shared area node.

This can be seen in FIG. 6. Where the system began with merged areas and only when a player leaves a merged area the system knows that there was at least two players on the area before splitting but it cannot assume that there is only one player in the two new areas generated by the split.

This is the simplest case where only two players merge in one common area. Generalizing this idea to the previous high level assumptions we have that the split can occur backwards a number of times when the blobs keep splitting (if there are several players in one blob). So the generalized methodology would back propagate.

The split logic follows a very simple rule, all players leaving a common area are matched to image features of them just before the merge, this in most cases allows the system to match players after a split.

If there is not enough confidence for the system to tell that a split blob belongs to a previous state, then a new state is inserted in the tree as new track record and the area is tracked inside this new track record, this represents the splitting of blobs and generation of new track records in the system.

Identifying characteristics include blob shape characteristics such as height, width, aspect ratios (e.g., height divided by width), or a normalized mass or area (e.g., pixel count) corrected for distance from the imaging device.

Identifiers for the track records can be added automatically, (e.g., sequential integers) or can be added manually before, during or after an event.

In certain specified situations, the normal video imaging device selection criteria for output can be suspended upon detection of cues indicative of, or associated with, special circumstances. For example, at the beginning of a basketball game, the video imaging device nearest the center of the court could be selected for the opening tip off.

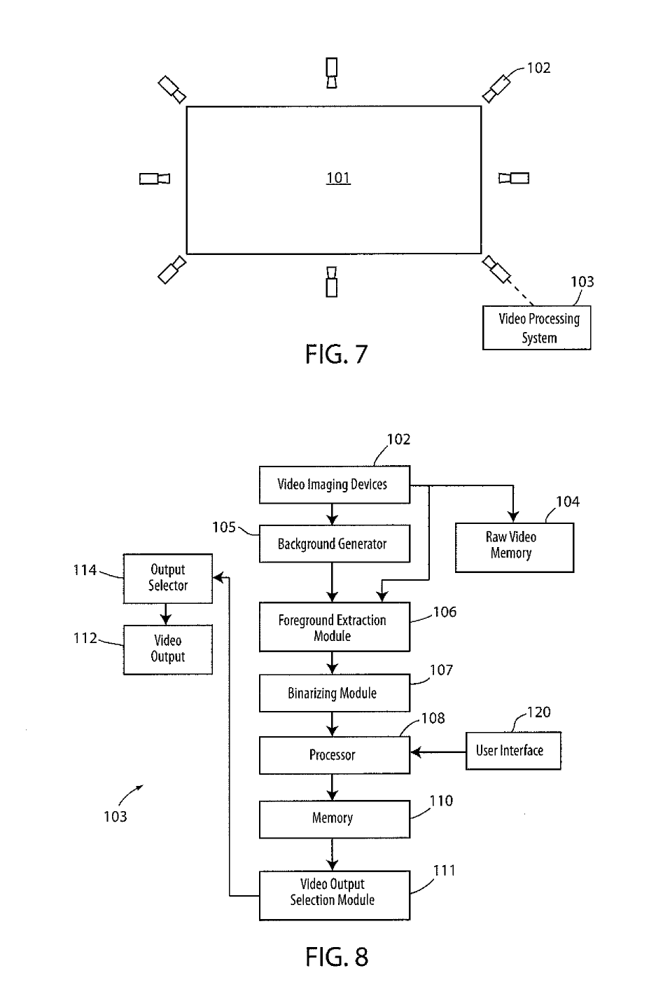

FIG. 7 shows the top view of a system 100 for generating a video output from a plurality of video feeds. The system 100 includes a venue 101, which can for example include a sports field or court, and a plurality of video imaging devices 102 located strategically to provide complete coverage of the venue from different perspectives. The video imaging devices are linked to a video processing system 103.

The video processing system 103 is illustrated schematically in FIG. 8, and includes the video imaging devices 102, and a background generator 105 that analyzes the video feeds from video imaging devices 102 to develop a background free of moving objects in the foreground. In certain embodiments, the feeds are digitally stored in a memory unit 104 (e.g., a computer hard drive) for future use, such as to generate a customized or personalized video production (e.g., that features a particular player in a sporting event). A foreground extraction module 106 subtracts the background from each feed to produce an extracted foreground image that is binarized in a binarizing module 107. The binarized images from the binarizing module is processed to determine centroid coordinates for each feed image and the coordinates of a circumscribing polygon having edges that coincide with outlying blobs in the image. The processor 108 is also useful for generating the track records for the individual blobs associated with moving objects in the venue. The track records can include an identifier associated with each blob and corresponding to a particular moving object in the venue (e.g., a player or a ball), coordinates for the object as a function of time, instantaneous velocities, cumulative movement (e.g., distance covered by the object during a game), and various other statistics that can be detected by analysis of the images (e.g., kicks, touches, passes, goals scored, etc.). Such statistics can be displayed in the output or provided in another suitable reporting format (e.g., printed report, video display, etc.). The various coordinates and other data can be stored on a memory 110 (e.g., a computer random access memory module) for subsequent use by the processor or by the video output selection module 111. The video output selection module 111 chooses a video feed for output 112. Data stored in the memory can be used to select a particular feed for the output 112 based on predetermined criteria (e.g., closest imaging device to the centroid of a particular video imaging device). The video output selection module 111 can signal an output selector 114 to channel a particular feed to the output to automatically produce a high quality video production of a live event. A user interface 120 can be linked with the processor to develop a customized video before, during or after the event, such as to feature a particular player at a sporting event in a playing field. The user interface can be remotely located, with the connection between the user interface 120 and processor 108 being via an internet connection.

This disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

1. A process for generating a video output from a plurality of video feeds generated by a corresponding plurality of video imaging devices capturing images of an event at a venue, comprising steps of:
(a) generating a background image for each video feed;
(b) subtracting the background image from each video feed to generate an extracted foreground image for each video feed;
(c) binarizing the extracted foreground image for each feed to generate a collection of blobs corresponding with objects in the extracted foreground image for each feed;
(d) calculating image coordinates for a centroid of the collection of blobs in the binarized extracted image for each video feed;
(e) calculating image coordinates for vertices of a polygon circumscribing the collection of blobs in each binarized extracted image for each video feed;
(f) storing the centroid and vertices image coordinates for each video feed;
(g) repeating steps (b) through (f) at regular time increments;
(h) selecting a feed for output based on at least one of the centroid coordinates and vertices coordinates over a first predetermined number of time increments; and
(i) repeating steps (a) through (h) to produce a video output during a duration of the event.

2. The process of claim 1, wherein at least one of the video imaging devices includes a pan function that facilitates at least one of rotation around a vertical axis and translation along a horizontal path, and wherein each video imaging device having a pan function is rotated around the vertical axis or translated along the horizontal path in response to centroid coordinate changes for the associated feed over a second predetermined number of time increments.

3. The process of claim 1, wherein at least one of the video imaging devices includes a tilt function that facilitates at least one of rotation around a horizontal axis and translation along a vertical path, and wherein each video imaging device having a tilt function is rotated around the horizontal axis or translated along the vertical path in response to centroid coordinate changes for the associated feed over a third predetermined number of time increments.

4. The process of claim 2 in which the rotation or translation is in a direction that compensates for displacement of the centroid away from a center point of the feed image.

5. The process of claim 2 in which rotation or translation in a direction that compensates for displacement of the centroid away from a center point of the feed image does not occur unless a predetermined threshold displacement is exceeded.

6. The process of claim 2 in which rotation or translation in a direction that compensates for displacement of the centroid away from a center point of the feed image is at a rate proportional to the rate of displacement of the centroid from a center point of the feed image.

7. The process of claim 3 in which the rotation or translation is in a direction that compensates for displacement of the centroid away from a center point of the feed image.

8. The process of claim 3 in which rotation or translation in a direction that compensates for displacement of the centroid away from a center point of the feed image does not occur unless a predetermined threshold displacement is exceeded.

9. The process of claim 3 in which rotation or translation in a direction that compensates for displacement of the centroid away from a center point of the feed image is at a rate proportional to the rate of displacement of the centroid from a center point of the feed image.

10. The process of claim 1, wherein at least one of the video imaging devices includes a zoom function that is adjusted in response to at least one of expansion of the polygon circumscribing the collection of blobs, contraction of the polygon circumscribing the collection of blobs, and movement of the centroid at a rate exceeding a predetermined value.

11. The process of claim 1, wherein at least one of the video imaging devices includes a zoom function that is adjusted in response to expansion and contraction of the polygon circumscribing the collection of blobs, and wherein the zoom function zooms out at a rate proportional to a rate at which the polygon expands and zooms in at a rate proportional to the rate at which the polygon contracts.

12. The process of claim 11, wherein the zoom function is not adjusted unless a predetermined threshold expansion or contraction has occurred.

13. The process of claim 1, further comprising calculating venue coordinates of a centroid associated with the image coordinates of the centroid of at least one of the video feeds, and selecting the video feed having an associated video imaging device that is nearest the venue coordinates of the centroid.

14. The process of claim 13 in which the step of selecting the video imaging device that is nearest the venue coordinates of the centroid does not occur unless the same video imaging device remains the video imaging device nearest the venue coordinates of the centroid for a predetermined time period.

15. The process of claim 1, in which a track record is maintained for each blob, each track record including at least an identifier for the associated blob, venue coordinates at each time increment calculated from the image coordinates of at least one of the video feeds, and at least one identifying characteristic.

16. The process of claim 15, in which blobs at each time increment are associated with a track record based on comparisons of at least one of image coordinates, venue coordinates, and at least one identifying characteristic.

17. The process of claim 16, in which a new track record with a new identifier is established for any new blob that could not be associated with an existing track record.

18. The process of claim 17, in which the track record of any blob that subsequently separates into at least two different blobs that can be associated with pre-existing blobs based on at least one corresponding characteristic, is appended to the track records of the pre-existing blobs.

19. The process of claim 15, in which identifiers are manually entered or changed before, during or after the event.

20. The process of claim 1, in which feed selection based on at least one of centroid coordinates and vertices coordinates is suspended upon detection of cues indicative of special circumstances.

21. A system for producing a video output displaying an event at a venue, comprising:
a plurality of video imaging devices that are capable of generating a video feed displaying an image of at least a portion of the venue;
a background generator module developing a background image for each video feed;
a foreground extraction module subtracting the background image for each video to develop an extracted foreground image for each video feed;
a binarizing module generating a collection of blobs corresponding with objects in the extracted foreground image for each feed;
a processor calculating image coordinates for a centroid of the collection of blobs in the binarized extracted image for each feed, and calculating image coordinates for vertices of a polygon circumscribing the collection of blobs in each binarized extracted image for each feed;
a memory module storing the centroid and vertices coordinates for each feed;
a controller instructing the modules and processor to repeat their functions at predetermined time increments; and
a selection module choosing a particular feed for output based on at least one of the centroid coordinates and the vertices coordinates
